(19) United States
(12) Patent Application Publication
(10) Pub. No.: US 2006/0140457 A1
(43) Pub. Date: Jun. 29, 2006

(54) Finger test site block

(76) Inventor: Elvin Simshauser, Columbus, NJ (US)

Correspondence Address: NATIONAL IP RIGHTS CENTER, LLC;SCOTT J. FIELDS, ESQ., 550 TOWNSHIP LINE ROAD, SUITE 400, BLUE BELL, PA, 19422, US

(21) Appl. No.: 11/024,150

(22) Filed: Dec. 28, 2004

(51) Int. Cl. G06K 9/00

(52) U.S. Cl. 382/124; 382/128

(57) ABSTRACT

The present invention relates to a finger sampling site selector comprising a peg and an image of a hand on a base with openings in the base corresponding to sampling locations on the hand. The peg is inserted into the opening corresponding to the current sampling location and serves to record the last sampling location. The device of the present invention maximizes available sampling sites and instructs as to sampling site progression.

### FIELD OF THE INVENTION

The present invention relates generally to a blood sampling locating device that assists a user in selecting a blood sampling site.

### BACKGROUND OF THE INVENTION

Blood sampling has been the most reliable way of determining blood levels of various substances. Repeat users of blood sampling devices such as diabetics have a need to frequently take a blood sample. This is typically accomplished by making a puncture with a spring loaded lancet to produce a drop or more of blood.

Puncture and sampling is performed one to four times a day or more. Repetitive sampling of the same location causes the buildup of scar tissue or callous making the use of the particular site difficult or impossible. The resulting effect on the finger is to build a callous on the finger and cause a buildup of tissue that prevents or complicates further sampling.

There is a need to provide a system of determining sampling locations that reduces the frequency of sampling at a particular location and minimizes the impact of the sampling.

However, it is difficult for a person sampling their own hands to keep definitive track of recent sampling sites.

Known solutions are memory for recalling the recently sampled sites, but this is difficult and unreliable for past days and weeks. This method does not maximize available sampling locations.

Another solution is to determine from recent punctures or soreness where the last sample was taken. This is not accurate and also does not definitively determine the last or next sampling site. The result is that the above methods under-sample a particular finger or present an additional burden to remember past and future sampling locations.

### OBJECTS OF THE INVENTION

It is an object of the present invention to provide a sampling locator that makes maximum use of available sampling sites, and reduces the frequency of sampling each individual site. It is a further object of the invention to provide a sampling method that preserves the tissue of the finger.

### SUMMARY OF THE INVENTION

The invention is defined by the appended claims with a specific embodiment shown in the attached drawings. For the purpose of summarizing the invention, the invention comprises a blood sampling site selector that preserves body tissue by reducing the frequency of sampling at individual locations. The site selector can be constructed from any durable material such as a block of wood or molded plastic. The selector is marked with a representation of the palm side of a hand including fingers and thumb. Each digit has at least one hole and preferably three holes spaced across the tip of the digit. The holes are suitable for receiving a peg to mark a particular hole in the finger where the marked hole corresponds to a sampling location on the finger. The present invention can be further marked with a sampling direction indicator such as an arrow. The peg is used to mark the current sampling location and to serve as a memory aid for the user. When the user is ready to take another sample, the peg remains inserted in the last sampling site. The user moves the peg to the next opening which instructs the next sampling site. The peg is preferably a bright color such as red.

In another preferred embodiment of the invention, a representation of the palm side of one hand is on presented on one side of the base and a representation of the other hand is presented on the other side of the base. This embodiment is particularly space efficient in that it presents both the right and left hands on opposite sides of the base. Where the base is formed from a wooden block or other material, the holes for the sampling sites can be drilled straight through the base. It is the nature of the shape of the human hand that the thumb and fingers will line up on opposite sides of the base and that a line drawn through the base will intersect, for example, the thumb of each hand on each side of the base.

In another preferred embodiment of the invention, the sampling locator comprises a representation of two hands in the palm up position situated side by side on the base. This embodiment of the invention allows the user to track sampling locations across all ten digits and maximize the available sampling area of the hands. The representations of the hands are labeled right hand and left hand and an arrow is included to indicate sampling direction.

The invention can be practiced with a slender peg having a slight taper or with a peg having a strong taper. A large head may be added to the peg to to facilitate handling.

### BRIEF DESCRIPTION OF THE DRAWINGS

The foregoing summary, as well as the following detailed description of a preferred embodiment of the present invention will be better understood when read with reference to the appended drawings, wherein:

FIG. 1 is a perspective view of the device of the invention representing one hand.

FIG. 2 is a perspective view of the device of the invention representing a left hand on the top surface and a right hand on the bottom surface.

FIG. 3 is a perspective view of an embodiment of the invention with images of a left hand and a right hand on the top surface of the base.

FIG. 4 is a view of the peg of the invention.

FIG. 5 is a view of an alternate peg of the invention.

### DETAILED DESCRIPTION OF THE DRAWINGS

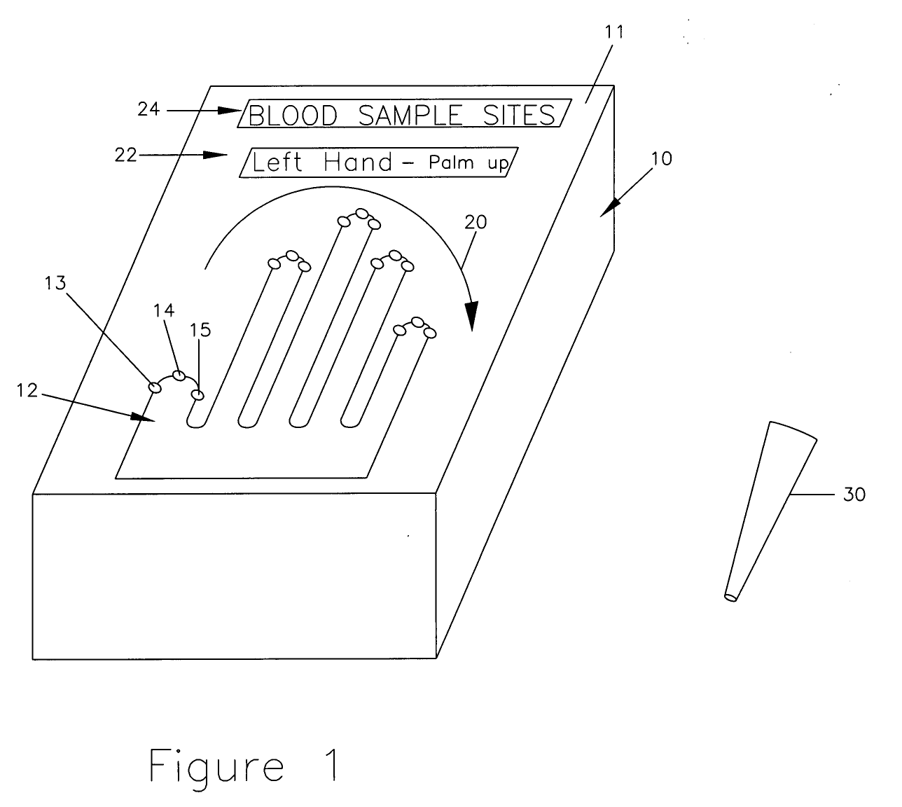

The present invention is described with reference to the enclosed figures. FIG. 1 shows the base 10 of the invention. The base 10 is in the shape of a block and formed of wood or plastic or other suitable material. The top surface 11 of the base 10 is marked with a representation of a hand 12 that is shown palm up. The representation of a hand 12 can be formed by engraving, painting, ink, a preprinted adhesive sticker, or other means known in the art. Formed in the base 10 is a multiplicity of openings in each digit and labeled in one digit as openings 13, 14, and 15. Opening 13 is representative of all the openings which have generally uniform dimensions. Opening 13 is suited to receive a peg 30 and is preferably formed through the base 10 to the other side of base 10. Opening 13 is placed on representation 12 to indicate a sampling location. Peg 30 is shown enlarged and is suited for placement in any opening, for example opening 13. Peg 30 is used to mark a sampling location.

Arrow 20 is marked on base 10 to show the sampling progression direction and where to move peg 30 to the proximate opening. Label 22 identifies which hand is displayed. Title 24 is included to identify the device. Peg 30 is ¼ inch to 2 inches long and preferably between ½ inch and 1 inch long. Peg 30 has a width of approximately 0.1 inches.

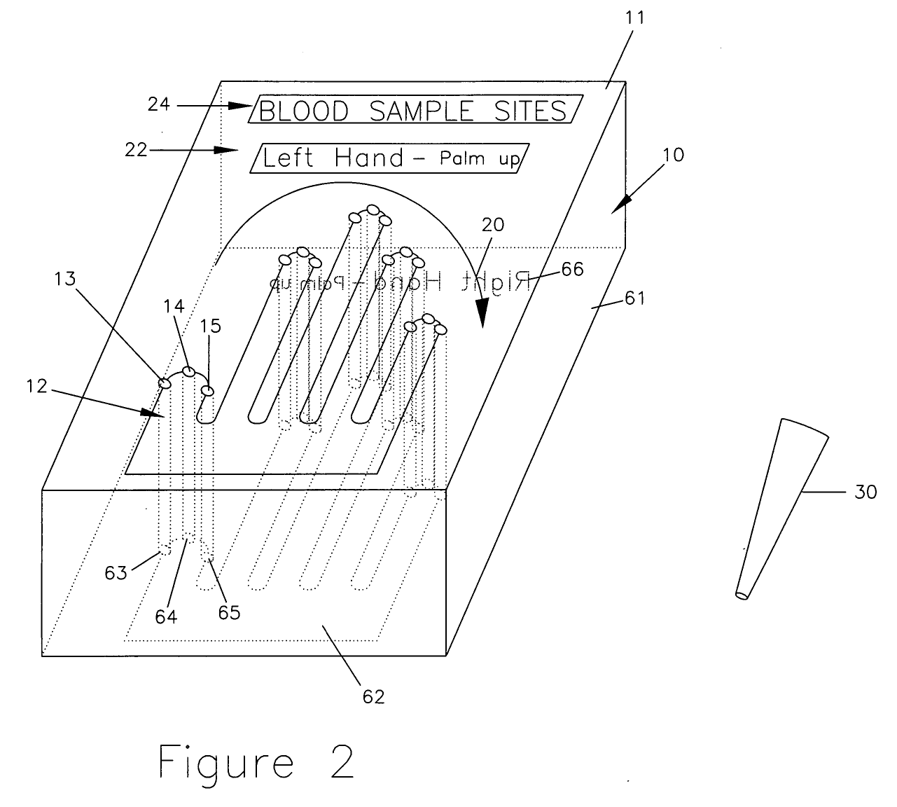

FIG. 2 shows another embodiment of the present invention where top surface 11 of base 10 is marked with a representation of a hand 12 that is shown palm up. Openings 13, 14 and 15 represent sampling locations on a particular digit. In this embodiment of the present invention, each digit is formed with three opening as shown, for example, as openings 13, 14, and 15. Bottom surface 61 of base 10 is also marked with a representation of a hand 62 that is shown palm up. On the bottom surface 61 of base 10 is a multiplicity of openings in each digit and labeled in one digit as openings 63, 64, and 65. Opening 63 is representative of all the openings which have generally uniform dimensions. Opening 63 is suited to receive peg 30, and opening 63 is preferably formed through the base 10 from top surface 11 to bottom surface 61.

Peg 30 is shown enlarged and is suited for placement in any opening, for example opening 13. Peg 30 is used to mark a sampling location.

Arrow 20 is marked on base 10 to show the sampling progression direction and where to move peg 30 to the proximate opening. For increased clarity, a directional arrow is not shown on the bottom surface 61, although inclusion of a directional arrow on bottom surface 61 is contemplated and hereby disclosed. Label 22 identifies which hand is displayed on surface 11. Label 66 also identifies which hand is displayed on surface 61. Title 24 is included to identify the device.

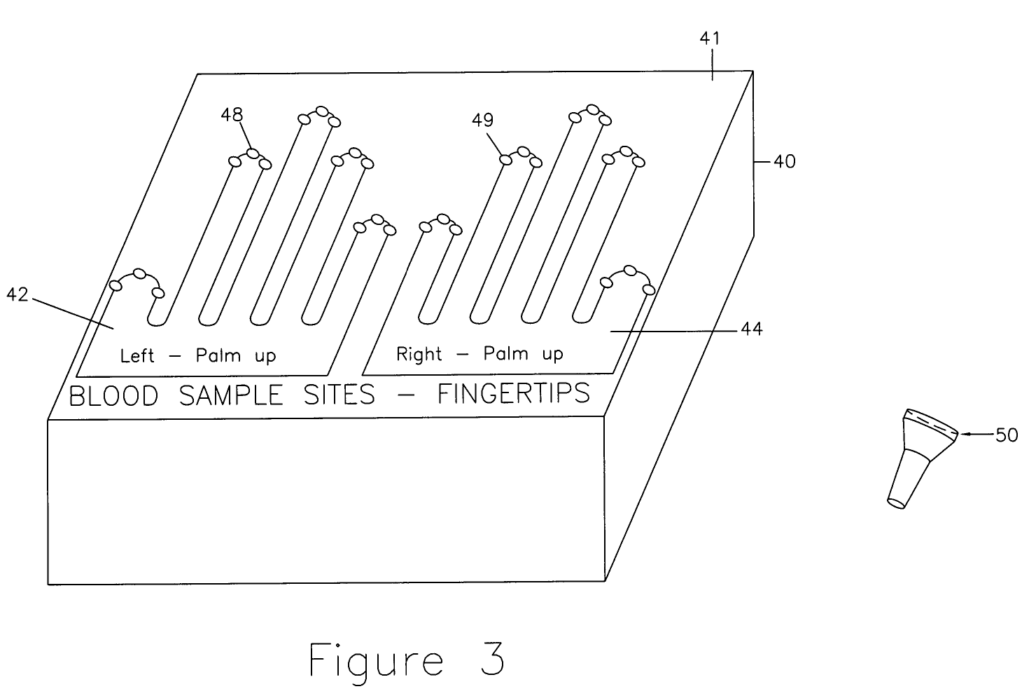

FIG. 3 shows another embodiment of the present invention where top surface 41 of base 40 is marked with a left hand 42 and a right hand 44. The left hand 42 is marked with three openings in each digit. Exemplary opening 48 is shown. The right hand 44 is also marked with three openings in each digit. Exemplary opening 49 is shown. Peg 50 is sized to fit into the openings, for example opening 48. Peg 50 is visually distinct from the base, preferably red. Peg 50 has a width of between 0.1 and 0.5 inches and a length of between 0.25 and 2 inches.

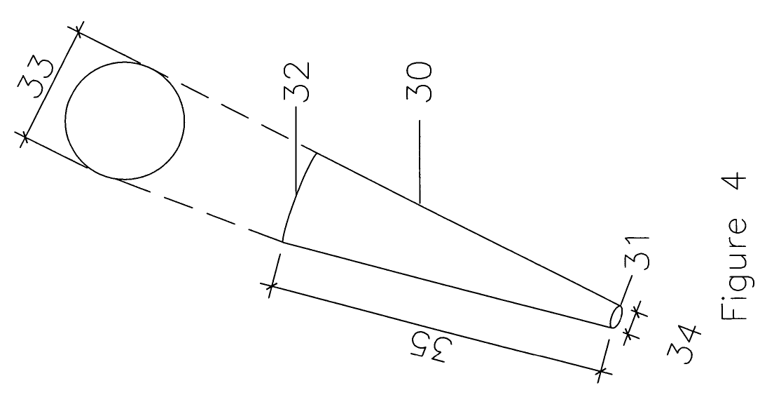

FIG. 4 shows a particular embodiment of peg 30. Peg top 32 and peg distal end 31 are shown. Peg 30 has length 35, peg top 32 has width 33, and peg distal end 31 has width 34. In this particular embodiment, width 33 is 0.1 inches, width 34 is 0.05 inches, and length 35 is 0.6 inches.

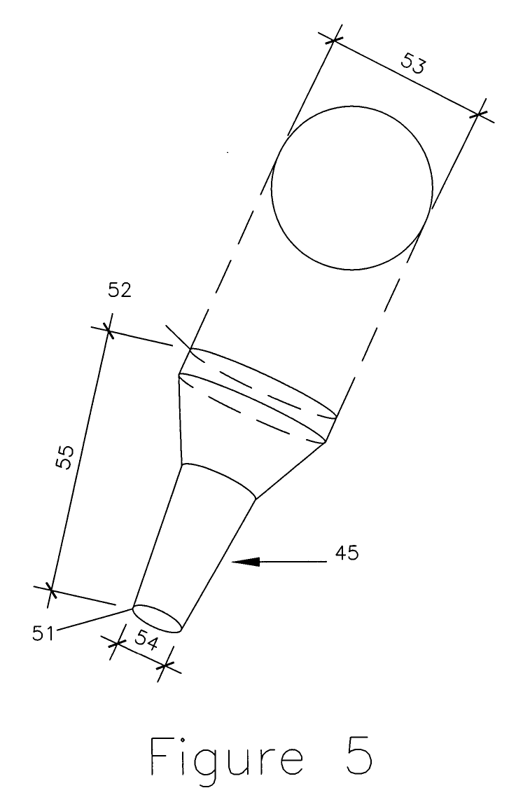

FIG. 5 shows a particular embodiment of peg 50. Peg top 52 and peg distal end 51 are shown. Peg 50 has length 55, peg top 52 has width 53, and peg distal end 51 has width 54. In this particular embodiment, width 53 is 0.25 inches, width 54 is 0.05 inches, and length 55 is 1.0 inches.

What is claimed is:

1. A finger sampling site selector comprising:
a peg, and an image of a hand on a base, at least one opening formed in said base located at each digit of said hand, where said opening is suitable for receiving said peg.

2. A finger sampling site selector comprising:
a peg and an image of a left hand and of a right hand on a base wherein each digit of said hand contains at least one opening suitable for receiving said peg; said left hand having five digits and said right hand having five digits.

3. A finger sampling site selector as in claim 2 wherein said five digits comprise four fingers and a thumb.

4. A finger sampling site selector as in claim 2 wherein said image of a left hand is on a first surface of said base and said image of a right hand is on a second surface of said base where said first surface and said second surface are on opposite sides of said base.

5. left hand is palm up and said right hand is palm up.

6. A finger sampling site selector as in claim 2 wherein each digit contains 3 openings in said base.

7. A finger sampling site selector as in claim 2 wherein said peg is red.

8. A finger sampling site selector as in claim 2 wherein said base further comprises indicia to give a user a sampling progression direction.

9. A finger sampling site selector as in claim 2 wherein said indicia is comprise an arrow.

10. A finger sampling site selector as in claim 2 wherein said indicia further includes a label on the representation to identify the left hand and the right hand and to indicate the orientation of the hand.

11. A finger sampling site selector as in claim 2 wherein said peg is tapered.

12. A finger sampling site selector as in claim 6 wherein said three openings are located one at the end of said digit, one at the left side proximate the end of said digit, and at the right side proximate the end of said digit.

13. A method of using the sampling site locator of claim 1 wherein a user places said peg in said sampling site locator in an opening corresponding to a finger sampling location; contemporaneous with the proximate sampling, the user moves the peg to the next available opening and samples the corresponding finger location.

14. A method of using the sampling site locator of claim 2 wherein a user places said peg in said sampling site locator in an opening corresponding to a finger sampling location; contemporaneous with the proximate sampling, the user moves the peg to the next available opening and samples the corresponding finger location.
